(19) United States
(12) Patent Application Publication
(10) Pub. No.: US 2003/0148048 A1
(43) Pub. Date: Aug. 7, 2003

(54) Ink-jet image recording material

(76) Inventors: Tomomi Yoshizawa, Tokyo (JP); Kazumasa Matsumoto, Tokyo (JP)

Correspondence Address: MUSERLIAN AND LUCAS AND MERCANTI, LLP, 600 THIRD AVENUE, NEW YORK, NY, 10016, US

(21) Appl. No.: 10/340,339

(22) Filed: Jan. 10, 2003

(30) Foreign Application Priority Data
Jan. 17, 2002 (JP) JP2002-008562

(51) Int. Cl. B41M 5/00

(52) U.S. Cl. 428/32.34; 428/32.3

(57) ABSTRACT

An ink jet image recording material and a preparation method thereof are disclosed. The ink receiving layer is produced by using a coating composition which comprises silica particles produced by a gas phase method each having a primary particle diameter for from 5 to 20 nm and silica particles produced by a wet precipitation method and a secondary particle formed by these silica particles each has a particle diameter measured by a light scattering method of from 50 to 1,000 nm.

### FIELD OF THE INVENTION

The invention relates to an ink-jet image recording material, particularly relates to a ink-jet recording material having an ink receiving layer having a plurality of voids and a method for producing the ink-jet recording material.

### BACKGROUND OF THE INVENTION

It has been known that an ink-jet recording material having an ink receiving layer having a plurality of voids is suitable for high-speed ink-jet printing. A dot image having a shape of near true circle and a high quality of image can be obtained by such the ink-jet recording material.

Such the ink receiving layer having a plurality of voids is constituted by extremely fine particles of silica produced by a gas phase method. The silica produced by the gas phase method has a problem that the cost thereof is considerably higher than that of colloidal silica or silica produced by a wet precipitation method. Accordingly, it is a technical object to obtain high ink absorbability by using the silica produced by gas phase method in an amount as small as possible. Moreover, the silica produced by the gas phase method tend to be coagulated since such the silica particle is extreme fine and has high surface activity. The particles are coagulated when the concentration of the coating composition is raised so as to cause problems such as that the feeding of the liquid is made difficult or unevenness of the coated layer is occurred. Therefore, the concentration of the coating composition can be difficultly made higher. It is necessary to coat a coating composition containing a large amount of water in a thick wet layer. Consequently, the coating speed cannot be raised by the process having the usual drying capacity, and a problem is caused that fine cracks are occurred when the evaporating speed is raised.

As a means for solving such the problem, Japanese Patent Publication Open to Public Inspection No. 2001-105720 describes a method in which the silica produced by gas phase method and colloidal silica are mixed and dispersed in water and stood for five or more days, then a water-soluble polymer is added to the liquid and the liquid is coated on a support. By such the method, the viscosity rising at the initial period is inhibited and a stable viscosity suitable for coating can be obtained. The ink receiving layer having a plurality of voids formed by such the coating composition has enough voids.

However, a producing space in which the dispersion is stood for five days is necessary since the dispersion must be stood for five days in this method; such the necessity of the space caused a particularly large problem when the production is continuously practiced. Moreover, it is difficult to make the concentration of the coating composition to high and large loading is loaded to the producing process. Such the problems cause raising the cost of the product.

### SUMMARY OF THE INVENTION

The object of the invention is to provide an ink receiving layer having a plurality of voids in a high ratio which has high ink absorbability and the highly concentrated coating composition for the layer can be produced within a short time by a lower cost, and to provide an ink-jet recording medium using the ink receiving layer.

The above-mentioned object can be attained by the following constitution.

An ink jet image recording material comprising a support and an ink receiving layer having a plurality of voids provides thereon, wherein the receiving layer is provided by coating a coating composition comprising silica particles having a mean particle diameter measured by a light scattering method from 50 to 1,000 nm, and the coating composition is prepared by employing silica particles produced by a gas phase method having an average primary particle diameter from 5 to 20 nm and silica particles produced by a wet precipitation method.

The ink jet image recording material as described above, wherein an average particle diameter of the silica particles produced by the wet precipitation method is from 50 to 1,000 nm.

The ink jet image recording material as described above, wherein diameter of the particle measured by observation of the surface of the ink receiving layer by an electronic microscope is of from 20 to 100 nm.

The ink jet image recording material as described above, wherein the weight ration of the silica produced by gas phase method to the silica produced by the wet precipitation method is from 0.1:1.0 to 1.0:1.0.

The ink jet image recording material as described above, wherein the silica produced by the gas phase method has a peak within the range of 200 to 400° C. in the spectrum of differential scanning calorimetry.

The ink jet image recording material as described above, wherein ratio of absorption at 3,200 cm⁻¹ to that at 1,600 cm⁻¹ in the infrared absorption spectrum (A₃₂₀₀/A₁₆₀₀) of the silica produced by the gas phase method is from 2.0 to 6.0.

The ink jet image recording material as described above, wherein the ink receiving layer comprises a cationic polymer.

The ink jet image recording material as described above, wherein weight ratio of the silica produced by gas phase method to the silica produced by wet precipitation method in the coating composition is from 0.1 to 1.0.

A method for producing the ink-jet recording material as described above, which comprises:

coating a coating composition which comprises silica particles produced by the gas phase method and silica particles produced by the wet precipitation method and has a content of the solid component of from 12 to 40% by weight, and drying the coated layer.

The method for producing the ink-jet recording material as described above, wherein the viscosity of the coating composition is from 30 to 300 mPa·s at a share rate of from 5,000 to 10,000/s.

The other embodiment of the invention is described.

(1) An ink receiving layer having a plurality of voids produced by using a coating composition which comprises silica particles produced by a gas phase method having an average primary particle diameter for from 5 to 20 nm and silica particles produced by a wet precipitation method and a secondary particle formed by these silica particles has a mean particle diameter measured by a light scattering method of from 50 to 1,000 nm.

(2) The ink receiving layer having a plurality of voids described in item 1 wherein the average particle diameter of the silica particles produced by the wet precipitation method is within the range of from 50 to 1,000 nm.

(3) The ink receiving layer having a plurality of voids described in item 1 or 2 wherein the diameter of the particle measured by observation of the surface of the ink receiving layer by an electronic microscope is within the range of from 20 to 100 nm.

(4) The ink receiving layer having a plurality of voids described in any one of item 1 to 3 wherein the weight ratio of the silica produced by gas phase method to the silica produced by the wet precipitation method is within the range of from 0.1 to 1.0.

(5) The ink receiving layer having a plurality of voids described in any one of item 1 to 4 wherein the silica produced by the gas phase method has a peak within the range of from 200 to 400° C. in the spectrum of differential scanning calorimetry.

(6) The ink receiving layer having a plurality of voids described in any one of item 1 to 5 wherein the ratio of absorption at 3,200 cm⁻¹ to that at 1,600 cm⁻¹ in the infrared absorption spectrum (A₃₂₀₀/A₁₆₀₀) of the silica produced by the gas phase method is within the range of from 2.0 to 6.0.

(7) An ink-jet recording material having the ink receiving layer described in any one of item 1 to 6.

(8) A method for producing the ink-jet recording material described in Item 7 comprising the steps of

coating a coating composition which comprises silica particles produced by the gas phase method and silica particles produced by the wet precipitation method and has a content of the solid component of from 12 to 40% by weight, and

drying the coated layer.

(9) The method for producing the ink-jet recording material described in item 8, wherein the viscosity of the coating composition is within the range of from 30 to 300 mPa·s at a share rate of from 5,000 to 10,000/s.

### DETAILED DESCRIPTION OF THE INVENTION

The invention is described in detail below.

The ink jet image recording material according to the invention has a porous ink receiving layer on a support. The ink receiving layer contains fine voids which receive and fix the jetted ink to form an image. The ink receiving layer is prepared by coating a coating composition comprising secondary silica particles having an average particle diameter measured by a light scattering method of from 50 to 1,000 nm.

The coating composition is prepared by employing a gas phase method each having an average primary particle diameter for from 5 to 20 nm and silica particles produced by a wet precipitation method and the secondary silica particles are formed. The coating composition comprises dispersant and further, if necessary, other component such as a binder resin, a surfactant, a cationic polymer, and so on.

The silica produced by the gas phase method, hereinafter referred to as the silica produced by gas phase method, and the silica produced by the wet precipitation method, herein after referred to as the silica produced by wet precipitation method, used in the invention are described. The silica produced by gas phase method is a kind of synthesized silica mainly composed of silicon dioxide; and is extremely fine particle silica synthesized by the method so-called dry process or gas phase process in which silicon tetrachloride is burned together with hydrogen and oxygen. The average primary particle diameter of the silica produced by gas phase is from 5 to 20 nm. Examples of such the silica produced by gas phase include AEROSIL series produced by Nihon Aerosil Co., Ltd., and Rheolosiel series produced by Tokuyama Corporation.

The silica produced by gas phase method to be used in the invention is preferably one having a peak at the range from 200 to 400° C. in the spectrum of differential scanning calorimetry. The peak being in such the ratio indicates the presence of an active silanol group in the silica. Such the silica particles can be form a large secondary particle by forming hydrogen bonding between the active OH groups at the particle surface. Thus formed secondary particle forms a void therein and functions as the ink receiving layer having a plurality of voids. The dispersion is often become high viscosity or gel in the course of the formation of the secondary particles. However, the variation of the viscosity is decreased and the state of the liquid is stabilized after certain period.

In the invention, the possibility of effective formation of the voids the shortening of the time for stabilization of the liquid and the making the high concentration liquid are investigated.

The silica produced by gas phase method is preferably one having the ratio of absorbability at 3,200 cm⁻¹ to that at 1,600 cm⁻¹ in the infrared absorption spectrum, A₃₂₀₀/A₁₆₀₀, of from 2.0 to 6.0. The silica particles having such the ratio are easily form a hydrogen bond with a stable Si-O-Si bonding and easily coagulated since the silanol group SiOH is on the particle surface in a high ratio.

Usually, the active OH group on the particle surface is very difficultly handled for forming an aqueous dispersion system. In the invention, the method for producing the ink- jet recording material can be provided by utilizing such the active OH group. In the method, the coating composition is used which has suitable coagulating ability, a shortened stabilizing time, and a high concentration and a lowered drying load by using a little amount of the silica produced by gas phase method and a relatively large amount of the silica produced by wet precipitation method.

The silica produced by wet precipitation method is described below. The silica produced by wet precipitation method is obtained by an acid treatment of an aqueous solution of water-soluble silicate.

Examples of the silica produced by wet precipitation method in clued Nipsil produced by Nippon Silica Industrial Co., Ltd., Finesil produced by Tokuyama Corporation, Sylycia produced by Fuji Sylycia Chemical Co., Ltd., Mizukasil produced by Mizusawa Chemical Industrial Co., Ltd., and Carplex produced by Shionogi & Co., Ltd. The above-mentioned are available in the market.

The silica produced by wet precipitation method and the silica produced by gas phase are mixed and are prepared by dispersion so as to have a mean particle diameter measured by a light scattering method of from 50 to 1,000 nm.

The foregoing silica produced by gas phase method and the silica produced by wet precipitation method are dispersed in an aqueous medium together with a surfactant or a binder to prepare a coating composition. The mean diameter of the secondary particle of silica formed in thus prepared coating composition is from 50 to 1,000 nm by the light scattering method. The measurement of the mean particle diameter by the light scattering method can be performed by a meter such as particle diameter distribution measuring apparatus LB-500 produced by Horiba Seisakusho Co., Ltd., using the dynamic light scattering system. The mean diameter is referred as volume surface mean diameter or Sauter mean diameter, which is detailed at page 261 of “Biryuusi Kogaku Taikei” (Outline of Fine particle Technique), issued by Fuji TechnoSystem, 2001.

Examples of binder include a hydrophilic polymer such as polyvinyl alcohol, polyvinylpyrrolidone, polyethylene oxide, polyacrylamide, sugars, gelatin and plullan. Among these polyvinyl alcohol is employed preferably.

A cationic polymer is preferably contained in the ink receiving layer of the ink-jet recording material according to the invention for raising the water resistively and the anti-spreading ability of the recorded image. The cationic polymer can be optionally selected from various cationic polymers.

The cationic polymer preferably which may be used in the invention is a polymer having a quaternary ammonium base, more preferably a homopolymer of a monomer having the quaternary ammonium base or a copolymer of such the monomer and one or more polymerizable monomers. A polymer having a weight average molecular weight of from 2,000 to 100,000 is particularly preferred. Examples of the monomer having the quaternary ammonium base are shown below.

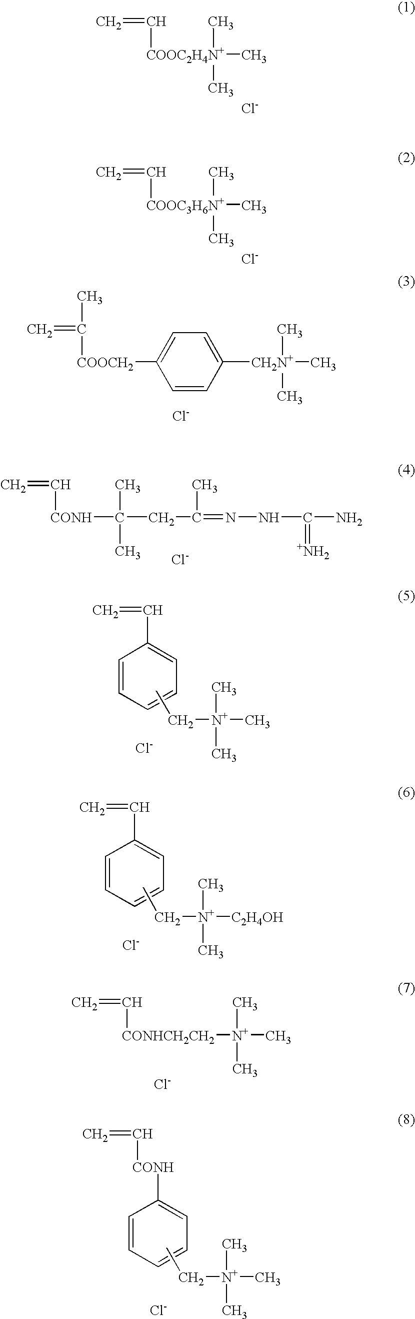

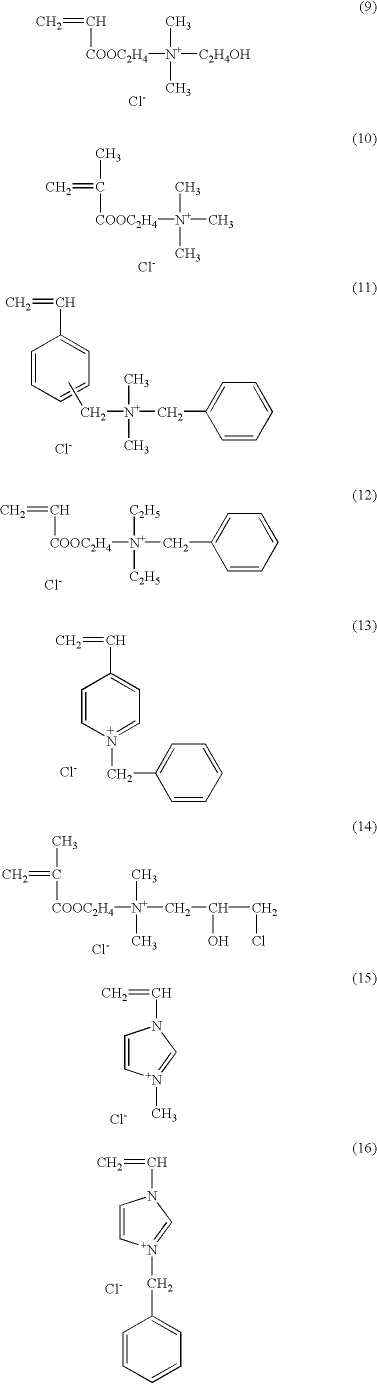

As the monomer co-polymerizable with the monomer having the quaternary ammonium base, a compound having an ethylenic unsaturated group is usable. For example, the followings are cited.

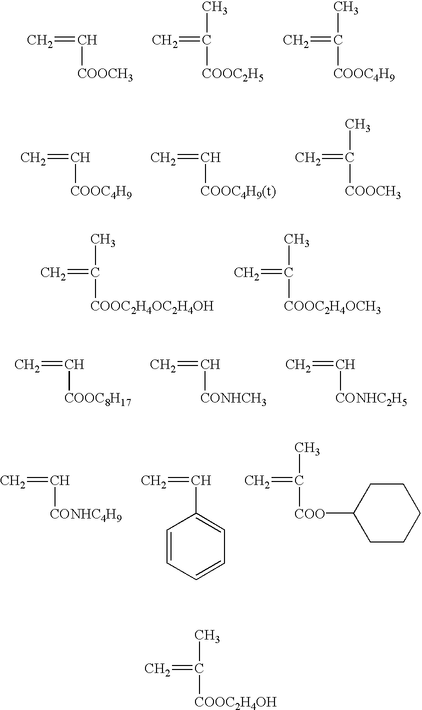

When the cationic polymer having the quaternary ammonium base is the copolymer, the ratio of the cationic monomer is preferably not less than 10 mole-%, more preferably not less than 20 mole-%, particularly preferably not less than 30 mole-%. The monomer having the quaternary ammonium may be used solely or in combination of two or more kinds. Concrete examples of the cationic polymer are shown below.

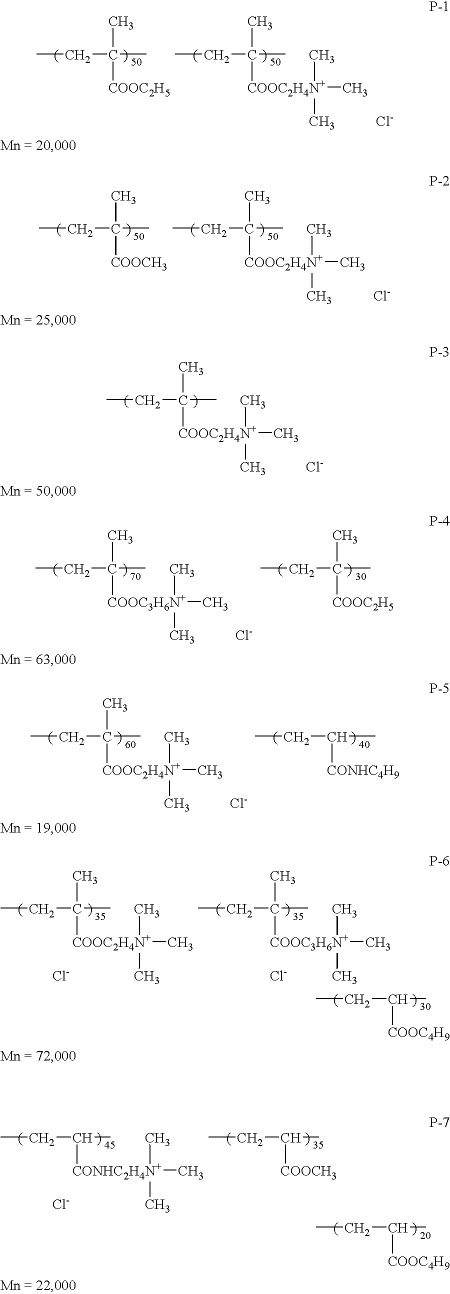

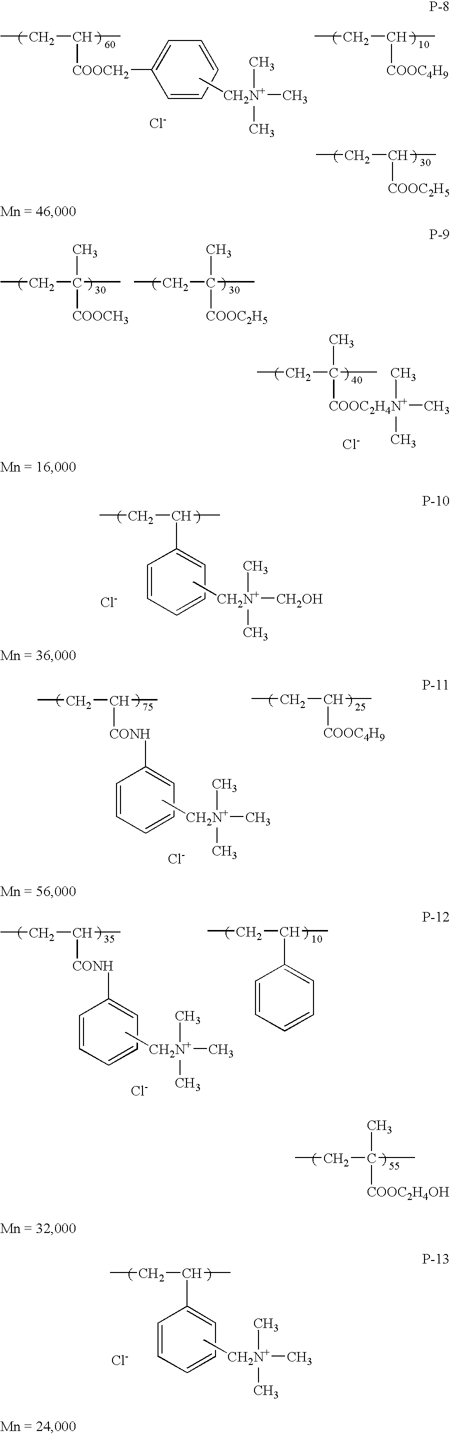

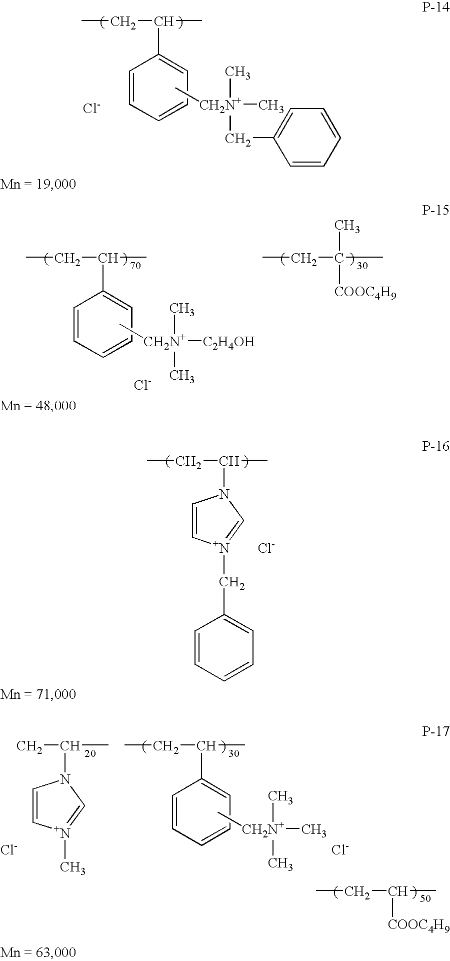

The cationic polymers having the quaternary ammonium base generally have high water solubility since they have the quaternary ammonium base. However, someone of them can not sufficiently dissolved in water according to the composition or the ratio of the monomer having no quaternary ammonium base. Such the polymer may be used in the invention when the polymer can be dissolved in a mixed solvent of water and a water-miscible organic solvent. A compound the prepared by hydrolysis and polycondensation of a silane coupling agent having a quaternary ammonium base structure can also be used as the cationic polymer.

Said water-miscible organic solvents, as described herein, refer to organic solvents including alcohols such as methanol, ethanol, isopropanol, and n-propanol; glycols such as ethylene glycol, diethylene glycol, and glycerin; esters such as ethyl acetate and propyl acetate; ketones such as acetone and methyl ethyl ketone; and amides such as N,N-dimethylformamide, which are soluble in water generally in a amount of at least 10 percent. In this case, it is preferable that the used amount of organic solvents is less than that of water.

The average molecular weight, as described herein, refers to the number average molecular weight, and also refers to ethylene glycol converted values obtained employing gel permeation chromatography.

When the number average molecular weight of the polymer exceeds 100,000, coagula are considerably occurred at the time of mixing of a solution of the cationic polymer to a dispersion containing inorganic fine particles which have anionic surface, and the mixture is difficultly become to an uniform dispersion even when a dispersing treatment after the mixing. Consequently, the uniform dispersion is difficultly obtained since many coarse coagula are remained. Particularly preferable number average molecular weight is 50,000 or less. The number average molecular weight of the cationic polymer is usually preferable not less than 2,000 from the viewpoint of prevention of spreading or caring away by water of the dye by absorption by the cationic polymer.

It is preferable to gradually add the silica produced by wet precipitation method to the cationic polymer solution for obtaining the stable dispersion since the cationicity of the dispersion is held all the time. In the course of the addition of the silica produced by wet precipitation method, it is preferred to sufficiently stir the mixture. A dispersing means is preferably applied in the course of or after the addition according to circumstances for raising the production efficiency.

For dispersing treatment, known various dispersing machines such as a high speed rotating dispersing machine, a medium stirring type dispersing machine such as a ball mill and a sand mill, a ultrasonic dispersing machine, a colloid mill dispersing machine, a roll mill dispersing machine and a high pressure dispersing machine can be used. Among them, the ultrasonic dispersing machine or the high pressure dispersing machine is preferable used since lumps of the fine particle formed in the process according to the invention can be effectively dispersed by such the dispersing machine.

The ultrasonic dispersing machine is usually radiate ultrasonic wave of from 20 to 25 kHz and condenses it at the solid-liquid interface to disperse the objective material; thus the dispersion can be effectively performed. However, such the method is not suitable for preparation of a large amount of the dispersion. On the other hand, the high pressure dispersing machine has one or two homogenizing valves attached at the exit of a high pressure pump having three or five pistons; the gap of the homogenizing valve can be controlled by a screw or oil pressure. The stream of the liquid medium fed by the high pressure pump is narrowed and pressed at the homogenizing valve and the fine lump of the material is dispersed at the moment of passing through the homogenizing valve.

Such the dispersing method is particularly preferred for preparing a lot of liquid since a large amount of liquid can be continuously dispersed by this method. The pressure applied to the homogenizing valve is usually from 5 to 100 MPa. The dispersion may be performed once or repeatedly.

The weight ratio of the silica produced by gas phase method to the silica produced by wet precipitation method in thus prepared coating composition is preferably within the range of from 0.1 to 1.0. When the ratio is within such the range, it is possible to prepare the stable coating composition in a short time, in which a small amount of the high cost silica produced by gas phase method is used and the voids can be effectively formed.

The concentration of the solid components other than solvent in thus prepared coating composition is preferably from 12 to 40% by weight. Thus, the concentration of the coating composition can be made relatively high and the load on the producing process can be reduced for raising the production efficiency.

The viscosity of the coating composition is preferably from 30 to 300 mPa·s at the sharing rate of from 5,000 to 10,000/s. The coating composition to be easily coated can be prepared according to the invention, which has a lowered viscosity even when the concentration of the liquid is relatively high.

Various kinds of additive may be added for preparing the coating composition. For example, various kinds of nonionic or cationic surfactant, any anionic surfactant is not preferable since it forms coagula, a defoaming agent, a hydrophilic nonionic polymer such as polyvinyl alcohol, polyvinylpyrrolidone, polyethylene oxide, polyacrylamide, sugars, gelatin and plullan, a nonionic or cationic latex, a water-miscible organic solvent such as ethyl acetate, methanol, ethanol, iso-propanol, n-propanol and acetone, inorganic salts, and a pH controlling agent are optionally usable according to necessity.

The ink jet recording material may contain fading resistant agents such as water-soluble reducing agents, sulfur-containing compounds, or hydrophobic antioxidant emulsified dispersions. Water-soluble reducing agents are described in Japanese Patent Publication Open to Public Inspection Nos. 8-300807, 8-150773, 8-108617, 9-267544, and others. Cited as those are, for example, sulfites, nitrites, phosphites, thiosulfates, ascorbic acid or salts thereof, hydroxylamine derivatives (N,N-diethylhydroxylamine, N,N-disulfoethylhydroxylamine sodium salt, N-hydroxyphthalimide, N,N-dicarboxyethylhydroxylamine sodium salt, and the like), glucose, and the like.

The sulfur-containing compounds are described in Japanese Patent Publication Open to Public Inspection Nos. 61-177279, 61-163886, 64-36479, 7-314883, 7-314882, 1-115677, and others. Cited as those are, for example, thiocyanates, thiourea, 2-mercaptobenzimidazole, 2-mercaptobenzthiazole, 2-mercaptobenzoxazole, 5-mercapto-l-methyltetrazole, 2,5-dimercapto-1,3,4-triazole, 2,4,6-trimercaptocyanuric acid, thiosalicylic acid, thiouracil, 1,2-bis(2-hydroxyethylthio) ethane and the like. Utilized as hydrophobic antioxidants may be antioxidants known in the art, such as described in, for example, Japanese Patent Publication Open to Public Inspection Nos. 57-74192, 57-87989, 1-115667, 3-13376, and others. Particularly preferred antioxidants are so-called hindered phenol based antioxidants, in which at least one of the hydroxyl groups in the ortho position is substituted with a tertiary alkyl group, piperidine based antioxidants (being so-called hindered amines) in which both of the two carbon atoms bonding to a nitrogen atom are substituted with alkyl groups, and antioxidants in which at least one hydroxyl group in the phenols or hydroxybenzenes is modified to ether by an alkyl group.

Aforementioned hydrophobic antioxidants are emulsifying-dispersed into a hydrophilic binder together with hydrophobic high boiling point organic solvents (such as di-2-ethylhexyl phthalate, di-i-decyl phthalate, tricresyl phosphate, tri-2-ethylhexyl phosphate, and the like), and the resulting dispersion is then added.

The ratio of the hydrophobic antioxidants to the high boiling point organic solvent is generally between 1:5 and 10:1, in terms of weight ratio.

In order to minimize such degradation bleeding, when boric acid or salts thereof, or water-soluble polyvalent metal ions are incorporated into the ink absorptive layer, said bleeding is minimized.

The water soluble polyvalent metal ions include divalent to tetravalent metal ions, and specifically, listed are Ca²⁺, Mg²⁺, Cu²⁺, Fe³⁺,, Ni²⁺, Co²⁺, Al³⁺,, and the like. Of these, Ca²⁺, Mg²⁺, Zn²⁺, and Al³⁺ are particularly preferred. The added amount of such polyvalent metal ions is generally between 0.1 and 10 millimoles per m² of the recording sheet. When said amount is less than 0.1 millimole, no noticeable effects are obtained. On the other hand, when said amount exceeds 10 millimoles, dye aggregation is enhanced and a bronzing phenomenon tends to occur on the surface. The said amount is most preferably between 0.2 and 2 millimoles. Various additive other than those mentioned above may be added to the ink receiving layer or other layer, provided by necessity, according to the invention.

The additives are listed: for example, polystyrene, polyacrylic acid esters, polymethacrylic acid esters, polyacrylamides, polyethylene, polypropylene, polyvinyl chloride, polyvinylidene chloride, or copolymers thereof; minute organic latex particles of urea resins or melamine resins; various types of cationic or nonionic surface active agents; UV absorbers described in Japanese Patent Publication Open to Public Inspection Nos. 57-74193, 57-87988, and 62-261476; anti-fading additives described in Japanese Patent Publication Open to Public Inspection Nos. 57-74192, 57-87989, 60-72785, 61-146591, 1-95091, and 3-13376; optical brightening agents described in Japanese Patent Publication Open to Public Inspection Nos. 59-42993, 59-52689, 62-280069, 61-242871, and 4-219266; pH regulators such as sulfuric acid, phosphoric acid, citric acid, sodium hydroxide, potassium hydroxide, and potassium carbonate; antifoaming agents, antiseptics, thickeners, antistatic agents, and matting agents. The porous ink receiving layer may be composed of two or more layers, and the composition of each layer may be the same or different.

In the ink-jet recording material according to the invention, boric acid and/or a borate are preferably contained in the ink receiving layer for raising the film forming ability of the ink receiving layer by formation of crosslinking therein. The boric acid or salt thereof is an oxygen acid having a boron atom as the center atom or a salt of such the acid. Concrete examples include orthoboric acid, diboric acid, metaboric acid, tetraboric acid, pentaboric acid, octaboric acid and salts thereof. The boric acid or the salt thereof is used within the range of from 0.05 to 2 g, preferably from 0.1 to 1 g, per square meter of the recording material.

The ink receiving layer has thickness of preferably from 20 to 50 μm, more preferably from 30 to 45 μm.

The support to be either used in the ink-jet recording material according to the invention may be a transparent or opaque support. Examples of the transparent support include films of polyester resin, diacetate resin, triacetate resin, acryl resin, polycarbonate resin, poly(vinyl chloride) resin, polyimide resin, cellophane and celluloid.

When the recording material is used for OHP, a support having a high resistivity against heat radiation is preferable; polyester resin is preferable and poly(ethylene terephthalate) particularly preferable from the viewpoint of the cost. The thickness of such the transparent support is preferably from approximately 10 to 200 μm.

Examples of preferable opaque support include resin coated paper so-called as RC paper composed of a raw paper and a polyolefin resin layer containing a white pigment coated on at least one of the sides of the raw paper, and white PET composed of polyethylene terephthalate containing a white pigment such as barium sulfate and titanium oxide. When a ink receiving layer is provided on the support, the support preferably subjected to a corona discharge treatment or a subbing treatment in advance to the coating of the ink receiving layer to raise the adhesive force between the support and the ink receiving layer. The ink-jet recording material according to the invention is not always necessarily colorless, and it may be tinted.

In the ink-jet recording material according to the invention, the use of a paper support laminated with polyethylene on the both sides thereof is particularly preferred since a high quality image near photographic image can be obtained with lower cost.

A paper support laminated with polyethylene on both side thereof is described. Paper employed in the supports of the present invention is made employing wood pulp as the main raw material and in addition, if desired, synthetic pulp such as polypropylene and synthetic fiber such as nylon and polyester. Employed as said wood pulp may be any of LBKP, LBSP, NBKP, NBSP, LDP, NDP, LUKP, and NUKP. However, it is preferable that LBKP, NBSP, LBSP, NDP, and LDP comprising short fiber component in a relatively large amount are preferably employed in a larger amount. Incidentally, the ratio of LBSP and/or LDP is preferably from 10 to 70 percent. Preferably employed as said pulp is chemical pulp (sulfate pulp and sulfite pulp) comprising minimal impurities. Further, also useful is pulp which has been subjected to a bleaching treatment to increase its whiteness.

Suitably incorporated into said paper may be sizing agents such as higher fatty acids and alkylketene dimer; white pigments such as calcium carbonate, talc, and titanium oxide; paper strength enhancing agents such as starch, polyacrylamide, and polyvinyl alcohol; optical brightening agents; moisture retention agents such as polyethylene glycols; dispersing agents; and softeners such as quaternary ammonium.

The degree of water freeness of pulp employed for paper making is preferably between 200 and 500 ml according to CSF Specification. Further, the sum of the weight percent of 24-mesh residue and the weight percent of 42-mesh calculated portion regarding the fiber length after beating, specified in JIS P 8207, is preferably between 30 and 70 percent. Further, the weight percent of 24-mesh residue is preferably 20 percent by weight or less. The weight of said paper is preferably from 30 to 250 g/m², and is most preferably from 50 to 200 g. The thickness of said paper is preferably from 40 to 250 μm.

During the paper making stage, or alternatively after paper making, said paper may be subjected to a calendering treatment resulting in excellent smoothness. The density of said paper is generally from 0.2 to 2 N (JIS P 8118). Further, the stiffness of said paper is preferably from 20 to 200 g under the conditions specified in JIS P 8143. Surface sizing agents may be applied onto the paper surface. Employed as said surface sizing agents may be the same as those above, capable of being incorporated into said base paper. The pH of said paper, when determined employing a hot water extraction method specified in JIS P 8113, is preferably from 5 to 9.

As polyethylene which covers both surfaces of the paper, low density polyethylene (LDPE) and/or high density polyethylene (HDPE) is primarily employed. However, other than these, LLDPE, polypropylene, and the like, may also be partially employed. Specifically, a polyethylene layer on the surface of an ink receiving layer is preferably one in which, as widely carried out in photographic paper, rutile- or anatase-type titanium oxide is incorporated into said polyethylene, and opacity and whiteness are improved. The content of titanium oxide is commonly between 3 and 20 percent by weight with respect to polyethylene, and is preferably between 4 and 13 percent by weight.

Polyethylene coated paper may be employed as a glossy paper. Further, polyethylene coated paper having a matte or silk surface may also be employed, which is used for the conventional photographic paper and prepared by embossing when polyethylene is melt-extrusion-coated onto the surface of the paper. The used amount of polyethylene on both surfaces of said paper is selected so as to optimize the layer thickness of a water based coating composition as well as curling at low and high humidity after providing a back layer. The thickness of the polyethylene layer on the side onto which the water based coating composition in accordance with the present invention is applied, is preferably from 20 to 40 μm, while the thickness of the polyethylene layer on the opposite side is preferably in the range of 10 to 30 μm.

Further, it is preferable that said polyethylene coated substrate exhibits the characteristics described below.

(1) Tensile strength is preferably from 20 to 300 N in the longitudinal direction and from 10 to 200 N in the lateral direction, in terms of the strength specified in JIS P 8113.

(2) Tear strength is preferably from 0.1 to 2 N in the longitudinal direction and from 0.2 to 2 N in the lateral direction in terms of the tear strength specified in JIS P 8116.

(3) Compression elasticity is no less than 10 MPa.

(4) Bekk surface smoothness is preferably at least 20 seconds under conditions specified in JIS P 8119, however so-called embossed papers may exhibit less than that.

(5) Opacity is preferably no more than 20 percent and is most preferably no more than 15 percent in terms of the transmittance of light in the visible region, which is determined under conditions of parallel light incidence/diffused light transmission.

It is possible to apply various types of ink absorptive layers and sublayers of the ink jet recording paper of the present invention, which are provided as required, onto a support, employing a method suitably selected from those known in the art. The preferred methods are such that the coating composition constituting each layer is applied onto a support and subsequently dried. In this case, it is possible to simultaneously apply at least two layers onto said support, and simultaneous coating is particularly preferred in which all hydrophilic binder layers are simultaneously coated.

Employed as coating methods are a roll coating method, a rod bar coating method, an air knife coating method, a spray coating method, and a curtain coating method. In addition, preferably employed is the extrusion coating method employing a hopper, described in U.S. Pat. No. 2,681,294.

The diameter of the silica particle comprising the silica particle by gas phase method and the silica produced by wet precipitation method at the surface of the ink receiving layer of the ink-jet recording material is from 20 to 100 nm when the particle diameter is measured by an electronmicroscope.

The particle diameter measured by the electronmicroscope can be obtained as the average of the diameters of at least 100 particles sampled from the electronmicroscopic photograph of the surface of the ink receiving layer.

### EXAMPLES

The invention is concretely described referring examples, but the invention is not limited thereto.

(Preparation of Aqueous Dispersion A of silica produced by wet precipitation method)

Silica produced by wet precipitation method having an average particle diameter of 9 μm and a primary particle diameter of 16 nm, Nipsil LP, produced by Nippon Silica Industry Co., Ltd., was dispersed with water by a sand grinder and then subjected to ultrasonic treatment. The dispersing treatment by the sand grinder and the ultrasonic wave were repeated so that the average particle diameter is become to 500 nm. Thus Aqueous Dispersion A containing 35% by weight of the silica was prepared.

### Example 1

(Preparation of Silica Mixture Dispersion B1)

Into 571 g of the above-prepared Aqueous Dispersion A, 50 g of Aerosil 300, silica produced by gas phase method having a primary particle diameter of 7 nm, produced by Nihon Aerosil Co., Ltd., was dispersed by a high speed rotary colloid mill Cleamix manufactured by M·Technic Co., Ltd., at a rotation speed of 10,000 r.p.m. for 20 minutes. Then the concentration of the mixed dispersion was made to 35% by weight by purified water. Thus Silica Mixture Dispersion B1 was prepared.

### Examples 2, 3 and Comparative example 1

(Preparation of Silica Mixture Dispersions B2, B3 and B5 respectively for Examples 2 and 3, and Comparative example 1)

Silica Mixture Dispersions B2, B3 and B5 respectively for Examples 2 and 3, and Comparative example 1 were prepared in the same manner as in Example 1 except that the amount of Aqueous Dispersion A and that of Aerosil 300, silica produced by gas phase method, were changed according to the description in Table 1.

### Example 4

(Preparation of Silica Mixture Dispersion B4)

Silica Mixture Dispersion B4 was prepared in the same manner as in Silica Mixture Dispersion B1 except that Aerosil 300, the silica produced by gas phase method, was replaced by Aerosil 200, silica produced by gas phase method having an average primary particle diameter of 12 nm, produced by Nihon Aerosil Co., Ltd.

### Comparative example 2

(Preparation of Silica Mixture Dispersion B6)

In 360 ml of purified water, 200 g of Aerosil 300,silica produced by gas phase method, was dispersed by the high speed rotary colloid mill Cleamix, manufactured by M·Technic Co., Ltd., at a rotation speed of 10,000 r.p.m. for 20 minutes. Then the concentration of the mixture dispersion was made to 35% by weight by purified water. Thus Silica Mixture Dispersion B comprising the silica produced by gas phase method was prepared.

Both of the silica produced by gas phase method Aerosil 300 and Aerosil 200 each has a peak within the range of from 200 to 400° C. in the differential scanning calorimetry spectrum measured by DSC6200, manufactured by Seiko Instruments Co., Ltd., at 25-500° C. and 10° C./min.

The amounts of the silica produced by gas phase method and that of the silica produced by wet precipitation method in thus obtained mixed silica dispersions are shown in Table 1.

TABLE 1

| | | | Silica | |
|---|---|---|---|---|
| | | | produced by | |
| | Silica produced by | | wet | |
| | gas phase method | | precipitation | |
| | | Added | method | |
| Mixed | Primary | amount | Added amount | |
| silica | particle | (Solid | (Solid | |
| dispersion | diameter | component) | component) | Remarks |
| B5 | 7 nm | 125 g | 125 g | Comparative |
| | | | | example 1 |
| B6 | 7 nm | 200 g | 0 | Comparative |
| | | | | example 2 |
| B1 | 7 nm | 50 g | 200 g | Example 1 |
| B2 | 7 nm | 75 g | 175 g | Example 2 |
| B3 | 7 nm | 100 g | 150 g | Example 3 |
| B4 | 12 nm | 50 g | 200 g | Example 4 |

(Preparation of Silica Mixture Dispersions D1 to D6)

Into 110 ml of Aqueous solution C1 containing 12% of cationic polymer P-1, 10% of n-propanol, 2% of ethanol and 2 g of defoaming agent SN381, produced by Sannobco Co., Ltd., having a pH of 2.5, 400 ml of each of the above-mentioned Silica Mixture Dispersions B1 through B6 was added while stirring at a rotation speed of 3,000 r.p.m. at the room temperature. Then 54 ml of Aqueous Solution E1 containing boric acid and borax in a weight ratio of 1:1, in each concentration of 3%, was gradually added to the silica mixture dispersion.

Next, the mixture was dispersed by a high pressure homogenizer Sanwa Kogyo Co., Ltd., at a pressure of 3,000 N/cm², and made up to 630 ml by purified water. Thus almost transparent Silica Dispersions D1 through D6 were prepared.

Silica Dispersions D1 through D6 were each filtered by TCP-30 type filter produced by Advantech Toyo Co., Ltd., having a filtering accuracy of 30 μm.

(Preparation of coating composition)

| | |
|---|---|
| One of Silica Dispersions D1 through D6 | 600 ml |
| Poly (vinyl alcohol) PVA203 10% solution | 5 ml |
| (Cralay Co., Ltd.) | |
| Poly (vinyl alcohol) PVA 235 6.5% solution | 270 ml |
| (Cralay Co., Ltd.) | |
| Latex AE803 (Showa Kobunshi Co., Ltd.) | 22 ml |
| Ethanol | 8 ml |

The above liquid was made up by purified water so that the solid component concentration was to be that described in Table 2.

When the concentration of the solid component is made to 15%, Comparative Example 2 could not be coated since the viscosity thereof is become too high.

Each of thus prepared coating compositions was filtered by TCPD-30 filter having a filtering accuracy of 20 μm, produced by Advantech Toyb Co., Ltd., and then filtered by TCPD-10 filter. The average particle diameter measured by the light scattering method and the viscosity of each of the coating compositions thus obtained are shown in Table 2.

The measurement of the particle diameter by the light scattering method was carried out by a dynamic grain size distribution measuring apparatus LB-500 manufactured by Horiba Seisakusho Co., Ltd.

TABLE 2

| | | Particle | | |
|---|---|---|---|---|
| | | diameter by | Solid | |
| | | light | component | |
| | | scattering | concen- | Viscosity |
| Coating | | method | tration | of coating |
| composition | Dispersion | (nm) | (%) | composition |
| Comparative | D5 | 1200 | 15 | 700 mPa · s |
| example 1 | | | | |
| Comparative | D6 | — | 15 | — |
| example 2 | | | | |
| Example 1 | D1 | 600 | 15 | 170 mPa · s |
| Example 2 | D2 | 720 | 15 | 130 mPa · s |
| Example 3 | D3 | 900 | 15 | 110 mPa · s |
| Example 4 | D4 | 500 | 15 | 150 mPa · s |

(Coating of recording medium)

Paper support coated with polyethylene on both sides thereof was used as the support; the thickness of the support was 220 μm and the polyethylene coated on the ink receiving side contained anatase type titanium oxide in a ratio of 13% by weight of polyethylene. The above-prepared coating composition was coated on the support so as that the wet layer thickness was 110 μm to prepare an ink-jet recording material. The coating was carried out according to the following procedure; the coating composition was heated by 40° C. and coated by a curtain coater at a coating speed of 230 m/min. Just after the coating, the coated support was cooled in a cooling zone maintained at 0° C. for 20 seconds, and dried for 60 seconds by wind of 20-30° C., for 60 seconds by wind of 45° C. and for 60 seconds by wind of 50° C., and then wound up as a role. Thus each of the ink-jet recording materials was prepared.

The following support having width of 1.5 m and length of 4,000 m and wound as role was used as the paper support.

Photographic raw paper having a moisture content of 8% and a weight of 170 g was used for preparing the paper support. Polyethylene layer having a thickness of 35 μm was coated on the surface of the raw paper by melt-extruding coating method, which contained 6% of anatase type titanium oxide. On the back surface of the raw paper, a polyethylene layer having a thickness of 40 μm was coated by the similar method. The surface side of the support was treated by corona discharge and coated by a subbing layer so that the coated amount of poly(vinyl alcohol) PVA 235, produced by Cralay Co., Ltd., was 0.05 g per square meter. The back surface was treated by the corona discharge treatment and a backing layer was coated thereon which contained about 0.4 g of a styrene/acrylate type latex binder having a Tg of about 80° C. , 0.1 g of a cationic polymer as a antistatic agent and 0.1 g of silica having a particle diameter of about 2 μm as a mating agent.

Thus obtained samples were each evaluated by the following methods with respect to the crack occurrence, the coated surface status and the surface glossiness. Results of the evaluation are shown in Table 3.

(Evaluation of crack occurrence)

Number of cracks occurred in 1 m² of each of the samples was counted and the samples were classified into three ranks according to the number of cracks as follows:

A: Less than 10

B: From 10 to lass than 100

C: 100 or more

(Evaluation of the coated surface status or unevenness of the surface)

A neutral gray image having a reflective density of about 0.1 was uniformly printed on the surface of each samples by Ink-jet Printer PM 770C, manufactured by Seiko-Epson Co., Ltd., and the occurrence of unevenness of the printed image was visually evaluated and classified into five ranks as follows:

A: No unevenness was observed.

B: Unevenness was slightly observed but any problem was not occurred on the printing of the uniform image.

C: Unevenness was detectable in the uniform printed image but almost no problem was occurred in practical printing.

D. Unevenness of the gray image was observed, which was unacceptable for practical printing.

E: Unevenness at a level unacceptable at all was observed.

In the above ranking, samples classified into D and E ranks have no commercial value in the practical use.

(Evaluation of glossiness)

The image reflectivity or glossiness value C in percent at 60 of the image of the solid black chart printed on each of the samples was measured by an image reflectivity measuring apparatus ICM-1DP, manufactured by Suga Testing Machine Co., Ltd., having an optical comb of 2 mm. The evaluation results were ranked as follows.

A: C value was not less than 61%.

B: C value was from 51 to 60%.

C: C value was from 41 to 50%.

D: C value was not more than 40%.

In the above ranking, it was concluded that the samples classified into Ranks A and B are preferable for the practical use.

TABLE 3

| | | Coating | |
|---|---|---|---|
| Sample | Crack | status | Glossiness |
| Comparative | D | B | C |
| example 1 | | | |
| Comparative | Cannot be | C | Cannot be |
| example 2 | coated | | coated |
| Example 1 | A | A | A |
| Example 2 | A | A | A |
| Example 3 | A | A | A |
| Example 4 | A | A | A |

It is understood that the excellent ink-jet recording material can be obtained which is inhibited in crack occurrence and superior in the coating status and the glossiness.

The excellent ink-jet recording material can be obtained which is inhibited in crack occurrence and superior in the coating status and the glossiness can be obtained according to the invention even when the coating composition prepared for a shortened timed.

1. An ink jet image recording material comprising a support and an ink receiving layer having a plurality of voids provided thereon, wherein
the ink receiving layer is provided by coating a coating composition comprising silica particles having a mean particle diameter measured by a light scattering method from 50 to 1,000 nm, and
the coating composition is prepared by employing silica particles produced by a gas phase method having an average primary particle diameter from 5 to 20 nm and silica particles produced by a wet precipitation method.

2. The ink jet image recording material of claim 1, wherein an average particle diameter of the silica particles produced by the wet precipitation method is from 50 to 1,000 nm.

3. The ink jet ink recording material of claim 1, wherein diameter of the particle measured by observation of the surface of the ink receiving layer by an electronic microscope is from 20 to 100 nm.

4. The ink jet image recording material of claim 1, wherein weight ratio of the silica produced by gas phase method to the silica produced by the wet precipitation method is from 0.1:1.0 to 1.0:1.0.

5. The ink jet image recording material of claim 1, wherein the silica produced by the gas phase method has a peak within the range of 200 to 400° C. in the spectrum of differential scanning calorimetry.

6. The ink jet image recording material of claim 1, wherein ratio of absorption at 3,200 cm⁻¹ to that at 1,600 cm⁻¹ in infrared absorption spectrum (A₃₂₀₀/A₁₆₀₀) of the silica produced by the gas phase method is from 2.0 to 6.0.

7. The ink jet image recording material of claim 1, wherein the ink receiving layer comprises a cationic polymer.

8. The ink jet image recording material of claim 1, wherein weight ratio of the silica produced by gas phase method to the silica produced by wet precipitation method in the coating composition is from 0.1:1.0 to 1.0:1.0.

9. A method for producing the ink-jet recording material of claim 1 comprising
coating a coating composition which comprises silica particles produced by the gas phase method and silica particles produced by the wet precipitation method and has a content of the solid component of from 12 to 40% by weight, and
drying the coated layer.

10. The method for producing the ink-jet recording material of claim 9, wherein viscosity of the coating composition is from 30 to 300 mPa·s at a share rate of from 5,000 to 10,000/s.
